(19) United States
(12) Patent Application Publication
(10) Pub. No.: US 2026/0322310 A1
(43) Pub. Date: Oct. 15, 2026

(54) METHOD FOR DETERMINING A TEMPERATURE OF AN ELECTRIC MACHINE

(71) Applicant: Robert Bosch GmbH, Stuttgart (DE)

(72) Inventors: Benjamin Mueller, Filderstadt (DE); Christian Hahn, Nuernberg (DE); Daniel Kuehbacher, Stuttgart (DE); Michael Bangerter, Markgroeningen (DE); Michele Hirsch, Esslingen (DE); Vincent Scharff, Ludwigsburg (DE); Yanhui Xu, Stuttgart (DE); Yuping Chen, Markgroeningen (DE)

(21) Appl. No.: 19/483,415

(22) PCT Filed: Apr. 23, 2024
(86) PCT No.: PCT/EP2024/061063

§ 371 Date: Nov. 11, 2025

(30) Foreign Application Priority Data
May 11, 2023 (DE) 10 2023 204 371.8

(51) Int. Cl. H02P 29/66; G01K 1/02; H02P 29/64

(52) U.S. Cl. CPC H02P 29/66; G01K 1/026; H02P 29/64

(57) ABSTRACT

The invention relates to a method for determining temperatures of an electric machine (100) having a rotor (110) and a stator (120), comprising: determining a first thermal computational model which models thermal variables of the stator (120); determining a second thermal computational model which models thermal variables of the rotor (110); determining a heat exchange between the rotor (110) and the stator (120) in the first thermal computational model and in the second thermal computational model independently of one another; determining a temperature of the stator (120) using the first thermal computational model; and determining a temperature of the rotor (110) using the second thermal computational model.

### BACKGROUND

The present invention relates to a method for determining a temperature of an electric machine, as well as to a computing unit and a computer program for the execution thereof.

It can be important for the operation of an electric machine to be able to determine the temperature of the stator as accurately as possible during operation of the machine in order to monitor thermally critical components of the stator, e.g. a stator insulation, and to be able to prevent damage. The more precisely the stator's temperature can be determined, the closer the stator's thermal limit can be approached during operation and thus the performance capability of the e-machine can be exploited or increased.

Accordingly, it can be significant to be able to determine the temperature of the rotor as accurately as possible. Component limit temperatures may also not be exceeded here in order to prevent, for example, demagnetization of permanent magnets or damage to a coil in the rotor.

For this purpose, for example in software on a control unit of the power part belonging to the electric machine (so-called inverter) a thermal protection model can be included in the calculation online (i.e. in operation).

### SUMMARY

Against this background, a method for determining a temperature of an electric machine as well as a computing unit and a computer program for carrying it out are proposed with the features of the disclosure. Advantageous embodiments are the subject of the following description.

The invention makes use of the measure of establishing thermal computational models for a rotor and a stator of an electric machine in which a heat transfer from one model to the other model does not have to be identical to the heat transfer from the other model into the one model, i.e. an energy conservation over the two models together is not required. No overall thermal model of the electric machine, including rotor and stator temperature, is thus established, rather two separate models are used with deliberate softening of (intentional non-adherence) to the energy balance between rotor and stator. The resulting degree of freedom significantly increases the model accuracy of the rotor and stator temperature. The apparently non-physical violation of energy conservation at first glance reflects the effect that heat thus flows from or into the system in question, which cannot or can only insufficiently be mapped with a model having a manageable network size (model size), i.e. it can nevertheless still be permitted (implicitly).

In detail, a thermal computational model of the stator is determined, provided or used as the first thermal computational model, which models or maps thermal variables or thermal parameters or thermal elements of the stator. This first thermal computational model is also subsequently referred to as a stator model. Furthermore, a thermal computational model of the rotor is determined, provided, or used as a second thermal computational model, which models or maps thermal variables, thermal parameters, or thermal elements of the rotor, respectively. This second thermal computational model is also hereinafter referred to as a rotor model. A heat exchange between the rotor and the stator is determined, modeled, observed, and considered independently in the first thermal computational model and in the second thermal computational model, respectively.

At least one temperature of the stator, hereinafter also referred to as the stator temperature, is determined using the first thermal computational model, and at least one temperature of the rotor, hereinafter also referred to as the rotor temperature, is determined using the second thermal computational model.

Depending on the particular temperatures of the stator and the rotor, the electric machine can be controlled. Due to the precise knowledge of the stator and rotor temperatures, the electric machine can be operated close to thermal temperature limits of thermally critical components without exceeding these temperature limits and without the potential for hazards or damage to the electric machine. The performance of the electric machine can thus be increased.

In the context of the present invention, the stator model and the rotor model are modeled independently of one another with respect to the actual heat exchange between the rotor and the stator. The heat or energy flow between the stator and the rotor is considered independently of one another in the two computational models and not linked 1 -to-1 with one another. Thus, the heat exchange determined in the stator model between the stator and rotor need not necessarily match the heat exchange determined in the rotor model. In particular, for the two computational models, it is not required that the amount of heat that the stator emits to the rotor is automatically identical to the amount of heat that the rotor receives from the stator.

Conventionally, in thermal computational models of electric machines, all energy flows between individual computational model elements are modeled as accurately as possible, and energy conservation within the computational model is required. For example, in such conventional computational models, the amount of heat that the stator emits to the rotor is automatically identical to the amount of heat that the rotor receives from the stator. However, such a computational modeling approach places very high demands for the knowledge of all heat flows present in the electric machine, including external faults. As a result, the achievable computational model accuracy can often be limited in practice, and the computational models can become very large and thus complex in terms of calculation cost and parameter identification.

The approach proposed here allows for a softening of the energy balance boundary condition by an “open” system model in which the system limits can be approached closer to the stator and the rotor influence can still be appropriately considered via a temperature boundary condition. The method is in particular independent of the type of computational modeling of the stator and rotor temperature model used. For example, both data-based and physics-based computational models can be combined.

According to one embodiment, the first thermal computational model and the second thermal computational model are not coupled or linked to one another via the heat exchange between the rotor and the stator as a boundary condition. Alternatively or additionally, no energy conservation between the first thermal computational model and the second thermal computational model regarding the heat exchange between the rotor and the stator is required as a boundary condition. The two computational models are thus not physically precisely aligned with one another, but rather considered physically independently of one another. In particular, no precise knowledge of all heat flows and external faults present in the electric machine is thus required. In this way, the rotor and stator temperatures can be determined more precisely and cost-efficiently with the aid of the independent computational models than would be the case with a physically precise overall model.

According to one embodiment, the first thermal computational model comprises an interface or an input for the temperature of the rotor, and the second thermal computational model comprises an interface or an input for the temperature of the stator, respectively. In particular, these interfaces are respectively intended as open interfaces for the heat exchange between rotor and stator. The interface of the stator model is in particular an external, open coupling to the rotor temperature and the interface of the rotor model is in particular an external, open coupling to the stator temperature. These interfaces allow the heat transfer between rotor and stator to be considered individually and independently in the two computational models. For example, via the interface of the stator model, the rotor temperature can be specified from the outside. For example, the rotor temperature determined using the rotor model can be passed on to the stator model via this interface. Conversely, the stator temperature can be specified externally via the interface of the rotor model, e.g. as the stator temperature determined using the stator model. The use of these open interfaces in particular leaves open the possibility of coupling the two computational models openly or loosely to one another.

According to one embodiment, operating parameters of the electric machine are determined. Depending on these determined operating parameters, the temperature of the stator is determined using the first thermal computational model, and the temperature of the rotor is determined using the second thermal computational model. For example, sensor values can be sensed as such operating parameters during the operation of the electric machine. Alternatively or additionally, the operating parameters can be determined as a function of such sensed sensor values. For example, these operating parameters can describe one or more working points of the electric machine, e.g. a first working point in relation to the stator and a second working point in relation to the rotor.

According to one embodiment, the thermal variables of the stator in the first thermal computational model and/or the thermal variables of the rotor in the second thermal computational model are modeled as a function of a torque and/or a speed and/or a phase current and/or a DC link voltage and/or a driving frequency and/or a modulation method of the electric machine, respectively. The phase current, the DC link voltage, the driving frequency, and the modulation method are in particular electrical operating parameters for actuating an inverter circuit for controlling the electric machine. The driving frequency can in particular be a carrier frequency of an underlying PWM-based actuation of power semiconductors. The modulation method can in particular be a driving method, e.g. a space vector modulation (SVPWM), a sinusoidal modulation, a sinusoidal modulation with a third harmonic or triangular offset, a flat top, a fundamental frequency clocking, etc.

Alternatively or additionally, according to one embodiment, the thermal variables of the stator and/or the rotor are each modeled as a function of a temperature of a cooling fluid for cooling the stator and/or a flow rate of the aforementioned cooling fluid for cooling the stator. This cooling fluid can be recirculated, for example, by a cooling system for cooling the stator and can be, for example, cooling water or cooling air.

Alternatively or additionally, according to one embodiment, the thermal variables of the rotor are each modeled as a function of a temperature of a cooling fluid for cooling the rotor and/or a flow rate of the aforementioned cooling fluid for cooling the rotor. For example, this cooling fluid can be passed through a hollow shaft of the rotor in order to cool the rotor as a rotor-internal fluid and can be, for example, a cooling oil.

Alternatively or additionally, according to one embodiment, the thermal variables of the rotor are each modeled as a function of a temperature of a gearbox oil. The gearbox can be positioned downstream of the electric machine so as to translate the torque generated by the electric machine.

According to one embodiment, the first thermal computational model maps thermal variables of a stator body and thermal variables of a stator coil of the stator as a function of one another. In the electric machine, the stator coil is suitably arranged within the stator body, e.g. within grooves within the stator body. The stator coil can protrude out of the stator body on both axial sides and can form a coil end there. Thus, with the aid of the stator model, a temperature of the stator body, in particular a maximum temperature within the stator body, and a temperature of the stator coil, in particular a maximum temperature within the stator coil, can be conveniently determined. For example, in the stator model, a first hotspot or a first thermal nodal point can be modeled, which maps the stator coil and its maximum temperature, and a second hotspot or a second thermal nodal point, which maps the stator body and its maximum temperature. It is expedient that thermal relationships or interactions between stator body and stator coil can be modeled, e.g. as correlations or linkages between these two nodal points.

According to one embodiment, the first thermal computational model models a temperature of the stator coil, a thermal power dissipation loss rate of the stator coil, and/or a thermal capacitance of the stator coil as thermal variables as a function of one another. For example, the first nodal point can map these three variables of the stator coil as a function of one another. Alternatively or additionally, the first thermal computational model according to one embodiment models a temperature of the stator body, a thermal power dissipation loss rate of the stator body, and/or a thermal capacitance of the stator body as a function of one another. For example, the second nodal point can map these three thermal variables of the stator coil as a function of one another. For example, the thermal power dissipation loss rate and the thermal capacitance of the stator coil as well as the thermal power dissipation loss rate and the thermal capacitance of the stator body can each be modeled as a function of a first working point of the electric machine related to the stator, wherein the aforementioned first working point describes, for example, a combination of current values for one or more of the following operating parameters: the torque, the speed, the phase current, the DC link voltage, the driving frequency, the modulation method, the temperature of the cooling fluid for cooling the stator, the flow rate of the cooling fluid for cooling the stator, a power dissipation loss rate of the stator, and the temperature of the rotor. The thermal capacitances of the stator coil and the stator body can each have constant values, for example, or they can also vary as a function of the current first working point. Decisive for the attainable accuracy is in particular the correct determination of the power dissipation loss rate of the stator body and the stator coil. These are expediently determined in each journal as a function of the current electrical and thermal working point.

Alternatively or additionally, the first thermal computational model according to one embodiment models a particularly variable thermal resistance between the temperature of the stator coil and the temperature of the stator body. For example, this thermal resistance can link the first nodal point and the second nodal point to one another. This thermal resistance is determined in particular as a function of the first working point.

Alternatively or additionally, the first thermal computational model according to one embodiment models a particularly variable thermal resistance between the rotor and the stator, in particular between the temperature of the rotor and the temperature of the stator body. For example, the temperature of the rotor can be specified as a boundary condition via the open interface. For example, this thermal resistance can link the second nodal point with respect to the stator body and the rotor temperature boundary condition to one another. For example, this thermal resistance is determined as a function of the speed of the electric machine and as a function of the first working point.

Alternatively or additionally, the first thermal computational model according to one embodiment models as a function of one another a temperature of the cooling fluid for cooling the stator, in particular as a boundary condition, as well as a particularly variable thermal resistance between the temperature of the stator body and the temperature of this cooling fluid for cooling the stator. This thermal resistance can, for example, link the second nodal point with respect to the stator body and the boundary condition with respect to the cooling fluid temperature. In particular, a first thermal resistance between the temperature of the stator body and the temperature of the cooling fluid can be modeled as a function of operating parameters of the electric machine, as well as a second thermal resistance between the temperature of the stator body and the temperature of the cooling fluid as a function of operating parameters related to the cooling fluid or the entire cooling system for cooling the stator. For example, this first thermal resistance between stator body temperature and cooling fluid temperature can be determined as a function of the first working point, and the second thermal resistance between stator body temperature and cooling fluid temperature can be determined as a function of a flow rate of the cooling fluid for cooling the stator and/or the temperature of the cooling fluid for cooling the stator.

According to one embodiment, in the stator model, the part of the stator coil within the grooves of the stator body and the part of the stator coil protruding out of the stator body in the form of the coil ends can be separately modeled. For this purpose, the first thermal computational model can model as thermal variables a temperature, a thermal power dissipation loss rate and/or a thermal capacitance of the stator coil in a coil groove of the stator as a function of one another. For example, a first nodal point can map these three variables of the coil groove as a function of one another. The first thermal computational model can further model as thermal variables a temperature, a thermal power dissipation loss rate and/or a thermal capacitance of a coil end of the stator as a function of one another. For example, a second nodal point can map these three variables of the coil end as a function of one another. In particular, the accuracy of the model can be improved in this way, because stator coil losses can be distributed into losses in the coil end and losses in the coil groove. The coil end losses and the coil losses can then each be fed into a separate nodal point. As explained above, the first thermal computational model can further model a temperature, a thermal power dissipation loss rate, and a thermal capacitance of the stator body, as a function of one another, wherein a third nodal point can map these three variables. Furthermore, a thermal resistance between the temperature of the stator coil in the coil groove and the temperature of the stator body can be modeled. This thermal resistance can be determined as a function of the first working point, for example. Alternatively or additionally, a thermal resistance between the temperature of the stator coil in the coil groove and the temperature of the coil end can be determined. This thermal resistance, too, can be determined as a function of the first working point, for example. Furthermore, a thermal resistance between the temperature of the stator body and the temperature of the cooling fluid for cooling the stator can be modeled.

According to one embodiment, the second thermal computational model models the temperature of the rotor, a thermal power dissipation loss rate of the rotor and/or a thermal capacitance of the rotor as a function of one another. For example, the temperature, thermal power dissipation loss rate, and thermal capacitance of the rotor can be mapped in a nodal point for the rotor. The thermal power dissipation loss rate and the thermal capacitance of the rotor can respectively be modeled as a function of a second working point of the electric machine related to the rotor, wherein this second working point describes a combination of current values for one or more of the following operating parameters: the torque, the speed, the phase current, the DC link voltage, the driving frequency, the modulation method, the temperature of the cooling fluid for cooling the stator, the flow rate of this cooling fluid for cooling the stator, the temperature of the cooling fluid for cooling the rotor, the flow rate of this cooling fluid for cooling the rotor, a power dissipation loss rate of the rotor, the temperature of the stator, and the temperature of the gearbox oil. For example, the thermal capacitance of the rotor can have constant values or can also vary as a function of the current second working point. In particular, the correct determination of the rotor power losses is significant for the achievable accuracy. This is expediently determined in each journal as a function of the current electrical and thermal working point.

Alternatively or additionally, the second thermal computational model according to one embodiment models a particularly variable thermal resistance between the rotor and the stator, in particular between the temperature of the rotor and the temperature of the stator. For example, the stator temperature can be specified as a boundary condition via the open interface.

For example, this thermal resistance can be determined as a function of the speed of the electric machine and the second working point.

Alternatively or additionally, the second thermal computational model according to one embodiment models the temperature of the cooling fluid for cooling the stator and a particularly variable thermal resistance between the rotor and the cooling fluid for cooling the electric machine as a function of one another. This thermal resistance can be determined in particular as a function of the speed and the second working point.

Alternatively or additionally, the second thermal computational model according to one embodiment models the temperature of the in particular rotor-internal cooling fluid for cooling the rotor and a particularly variable thermal resistance between the rotor and the cooling fluid for cooling the rotor as a function of one another. This thermal resistance is determined, for example, as a function of the speed, the temperature, and the flow rate of the cooling fluid for cooling the rotor as well as the second working point.

Alternatively or additionally, according to one embodiment, the second thermal computational model models the temperature of the gearbox oil and a particularly variable thermal resistance between the rotor and the gearbox oil as a function of one another. This thermal resistance is determined as a function of the speed and the second working point, for example.

According to one embodiment, the electric machine comprises a temperature sensor arranged on or in the stator. The first thermal computational model then models as thermal variables a temperature of the temperature sensor and/or a thermal capacitance of the temperature sensor as a function of one another. This thermal capacitance of the temperature sensor can be a fixed value or can also vary as a function of the first working point discussed above.

Alternatively or additionally, the stator model according to one embodiment models a particularly variable thermal resistance between the temperature of the stator coil, the temperature of the stator body, and the temperature of the temperature sensor. For example, this thermal resistance can be determined as a function of the speed and the first working point.

Alternatively or additionally, the stator model according to one embodiment models a particularly variable thermal resistance between the temperature of the cooling fluid for cooling the stator and the temperature of the temperature sensor. This thermal resistance can be determined in particular as a function of the speed and the first working point.

Alternatively or additionally, the stator model according to one embodiment models a particularly variable thermal resistance between a temperature of an oil, in particular a cooling oil for cooling the electric machinery, and the temperature of the temperature sensor, wherein this thermal resistance can be determined in particular as a function of the speed, the temperature of the oil, and the first working point.

For example, without the use of such a temperature sensor, a base version of the stator model can be provided as a pure forward simulation. This sensorless approach allows for residual errors to remain, which can be further reduced with an extension of the base model using the stator temperature sensor. For example, in the stator model, the individual thermal variables with respect to the temperature sensor can be connected to the nodal point with respect to the stator coil. Using the stator temperature sensor, the accuracy of the stator hot spot temperature prediction can be increased by evaluating the deviation between the measured sensor temperature and the expected modeled temperature and, for example, a weighted feedback into the stator model.

For example, a Luenberger Observer, Kalman filter, and/or PI regulator can be used for this purpose.

According to one embodiment, in the first thermal computational model, the temperature sensor can also be modeled by two temperatures. For the purpose, the first thermal computational model can model as thermal variables a first temperature of the temperature sensor and/or a second temperature of the temperature sensor and/or a first thermal capacitance of the temperature sensor and/or a second thermal capacitance of the temperature sensor as a function of one another. In this way, in order to improve the model, the temperature sensor can be mapped by two nodes. Alternatively or additionally, the stator model according to one embodiment models a first thermal resistance between the temperature of the stator coil and the first temperature of the temperature sensor and/or a second thermal resistance between the first temperature of the temperature sensor and the second temperature of the temperature sensor and/or a third thermal resistance between the temperature of the cooling fluid for cooling the stator and the second temperature of the temperature sensor. These three thermal resistances can respectively be determined, for example, as a function of the speed and the first working point.

According to one embodiment, the electric machine comprises an oil cooling. In such an oil-cooled electric machine, also referred to as a wet electric machine, with oil in a rotor-stator gap, the stator and its coil are in direct contact with the oil. The first thermal computational model then models as thermal variables a temperature of the oil of the oil cooling and a particularly variable thermal resistance between the temperature of the oil of the oil cooling and the temperature of the stator coil as a function of one another. This additional cooling path of the oil cooling can be mapped in the stator model, for example by linking the first nodal point with respect to the stator coil to the oil temperature. The oil temperature can be provided, for example, by an oil temperature sensor or by an oil temperature model. If the stator temperature sensor is also in direct contact with the oil, this can be modeled by additional linkage of the sensor nodal point to the oil temperature. The thermal resistance between the temperatures of the oil and the stator coil depends in particular on the speed and on a third working point, where this third working point is in particular a current combination of torque, speed, phase current, DC link voltage, driving frequency, modulation method, cooling fluid temperature (for cooling the stator), flow rate of the cooling fluid (for cooling the stator), oil temperature, oil flow rate, stator power dissipation loss rate, and/or rotor temperature. In this case, too, a feedback of the sensor information, e.g. in the context of an observer approach, as mentioned above, can improve the estimation of the stator hotspot temperature.

The present method is particularly suitable for use in the automotive sector, e.g. in a hybrid or electric vehicle. Using the method, the temperature of the electric machine can be precisely determined and used, for example, in the course of an engine control.

A computing unit according to the invention, e.g. a control unit of a motor vehicle, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control unit is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g. via a WLAN, a 3G, 4G, 5G, or 6G connection, etc.).

### BRIEF DESCRIPTION OF THE DRAWINGS

Further advantages and embodiments of the invention will emerge from the description and the accompanying drawing.

The invention is illustrated schematically in the drawing on the basis of exemplary embodiments and is described in the following with reference to the aforementioned drawing.

FIG. 1 schematically shows an electric machine that can be the basis of an embodiment of the method according to the invention.

FIG. 2 schematically shows a thermal computational model, which models thermal variables of a stator of an electric machine according to one embodiment of the method according to the invention.

FIG. 3 schematically shows thermal computational models, each of which models thermal variables of a stator of an electric machine, respectively according to one embodiment of the method according to the invention.

FIG. 4 schematically shows a thermal computational model, which models thermal variables of a rotor of an electric machine according to one embodiment of the method according to the invention.

FIG. 5 schematically shows a temperature-time plot, which can be determined in the context of an embodiment of the method according to the invention.

### DETAILED DESCRIPTION

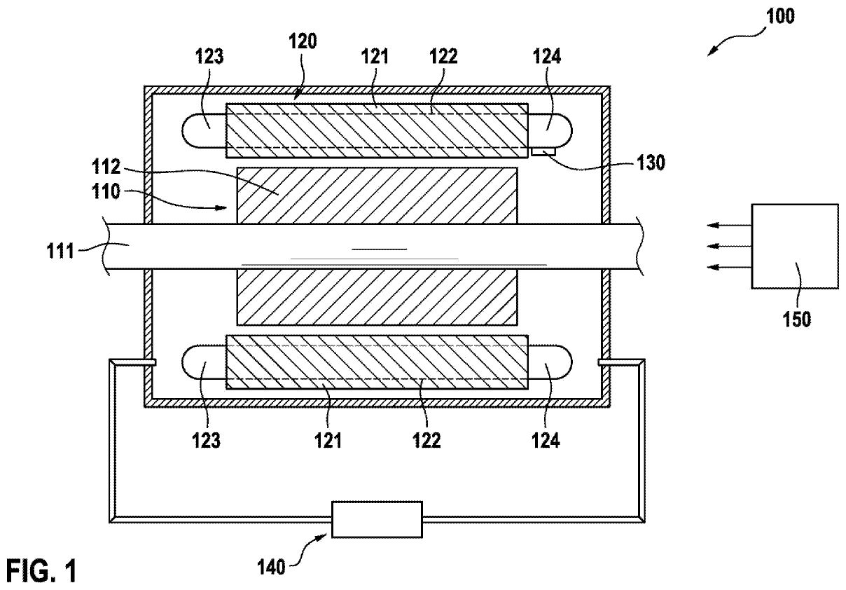

In FIG. 1, an electric machine is shown in a schematic cross-sectional view and bears the reference number 100. For example, the electric machine 100 can be used in a vehicle, such as in a hybrid or electric vehicle.

The electric machine 100 comprises a rotor 110 having a rotor body 112 arranged on a rotor shaft 111, as well as a stator 120 surrounding the rotor 110. The stator 120 comprises a stator body 121, in which a stator coil 122 is arranged, in particular in coil grooves of the stator body 121. The stator coil 122 protrudes on both axial sides of the stator body 121 and forms a coil end 123, 124 there, respectively. The stator body 121 can be produced from iron or an iron alloy, e.g. steel or sheet metal, and provided as a laminated stack, for example.

For example, the stator coil 122 can be produced from copper or a copper alloy.

A temperature sensor 130, e.g. a hot conductor thermistor with a negative temperature coefficient (NTC thermistor), is arranged on the stator 120, e.g. in the coil end 124 of the stator coil 122.

A cooling system 140 is provided in order to transport a cooling fluid or a plurality of cooling fluids for cooling the rotor and/or the stator and/or the entire electric machine 100. Such cooling fluids can be, for example, cooling water, cooling air, or a cooling oil.

A control unit 150, e.g. an engine control unit of the vehicle, is provided for controlling the electric machine 100 and can comprise an inverter switch, for example.

In order to be able to precisely and reliably determine temperatures of the rotor 110 and the stator 120 during operation of the electric machine 100, the control unit 150 is, in particular, programmatically configured so as to carry out an embodiment of a method according to the invention. In the course thereof, a first thermal computational model, which models thermal parameters of the stator 120, and a second thermal computational model, which models thermal parameters of the rotor 110, are carried out in the control unit 150 independently of one another. These computational models can be determined or created, for example, in the course of a manufacturing or configuration process of the electric machine 100 and stored in the control unit 150. During the operation of the electric machine 100, the control unit 150 determines a temperature of the stator 120 using the first thermal computational model or stator model and a temperature of the rotor 110 using the second thermal computational model or rotor model. Depending on these determined temperatures, the control unit 150 actuates the electric machine 100, for example, such that the machine 100 can operate close to thermal limit temperatures of thermally critical components of the stator 120 and the rotor 110 without risks or damage to the electric machine 100.

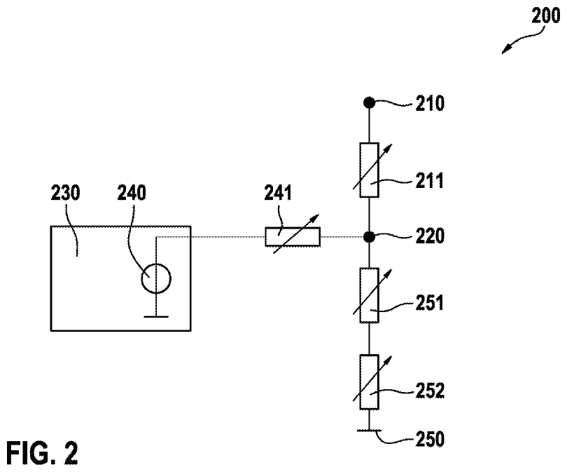

The determination of the independent stator and rotor models according to one embodiment of the present invention is explained below in relation to FIGS. 2 to 5.

In FIG. 2, a stator model according to one embodiment of the method according to the invention is shown schematically and bears the reference number 200.

The stator model 200 comprises an interface 230 for the temperature 240 of the rotor 110. This interface 230 provides an open interface for the heat exchange between the rotor 110 and the stator 120 and an external, open coupling to the temperature 240 of the rotor 110. Via this interface, the heat exchange between the rotor 110 and the stator 120 can be considered independently of the rotor model. For example, the rotor temperature 240 can be manually or externally specified via the interface 230, e.g. as a result of the rotor model.

In the stator model 200, thermal variables of the stator body 121 and thermal variables of the stator coil 122 are mapped as a function of one another. For example, in the stator model 200, a first hotspot or a first thermal nodal point 210 is modeled, which maps the stator coil 122. For example, this first nodal point 210 can map a temperature T_{stator,Cu} of the stator coil 122, a thermal power dissipation loss rate P_{v,stator,Cu} of the stator coil 122, and a thermal capacitance C_{cu} of the stator coil 122 as a function of one another.

Furthermore, in the stator model 200, a second hotspot or nodal point 220 is modeled, which maps the stator body 121. For example, this second nodal point 220 can map a temperature Tstator,Fe of the stator body 121, a thermal power dissipation loss rate P_{v,stator,Fe} of the stator body 121, and a thermal capacitance C_{Fe} of the stator body 121 as a function of one another.

For example, the thermal power dissipation loss rate P_{v,stator,Cu} and the thermal capacitance C_{Cu} of the stator coil 122 as well as the thermal power dissipation loss rate P_{v,stator,Fe}and the thermal capacitance C_{Fe} of the stator body 121 can respectively be modeled as a function of a first working point related to the stator 120. For example, this first working point describes a combination of current values for a torque, a speed, a phase current, a DC link voltage, a driving frequency, a modulation method, a temperature of a cooling fluid for cooling the stator 120, a flow rate of the aforementioned cooling fluid for cooling the stator 120, a power dissipation loss rate of the stator 120, and the temperature of the rotor 110.

In the stator model 200, a variable thermal resistance 211 between the temperature of the stator coil 122 and the temperature of the stator body 121 is modeled, wherein this thermal resistance 211 links the first nodal point 210 and the second nodal point 220 with one another. This thermal resistance 211 is determined as a function of the first working point, R_{Cu}=h(Op₁).

Furthermore, in the stator model 200, a variable thermal resistance 241 between the rotor 110 and the stator 120 is modeled, which, for example, links the second nodal point 220 and the rotor temperature 240 with one another as a boundary condition. For example, this thermal resistance 241 is determined as a function of the speed of the electric machine 100 and as a function of the first working point, R_{Rot}=f(n_{Em}, Op₁).

The stator model 200 further models the temperature 250 of the cooling fluid for cooling the stator and a first thermal resistance 251 and a second thermal resistance 252 between the temperature of the stator body 121 and the temperature 250 of the cooling fluid. This cooling fluid can be conveyed, for example, with the aid of the cooling system. These thermal resistances 251, 251 can link the second nodal point 220 and the temperature 250 of the cooling fluid with one another as a boundary condition. For example, the first thermal resistance 251 can be determined as a function of the first working point, R_{Fe1}=k(Op₁). For example, the second thermal resistance 252 can be determined as a function of the temperature and flow rate of the cooling fluid, RFe2=g(V′_{Coolingfluid}, T_{Coolingfluid})

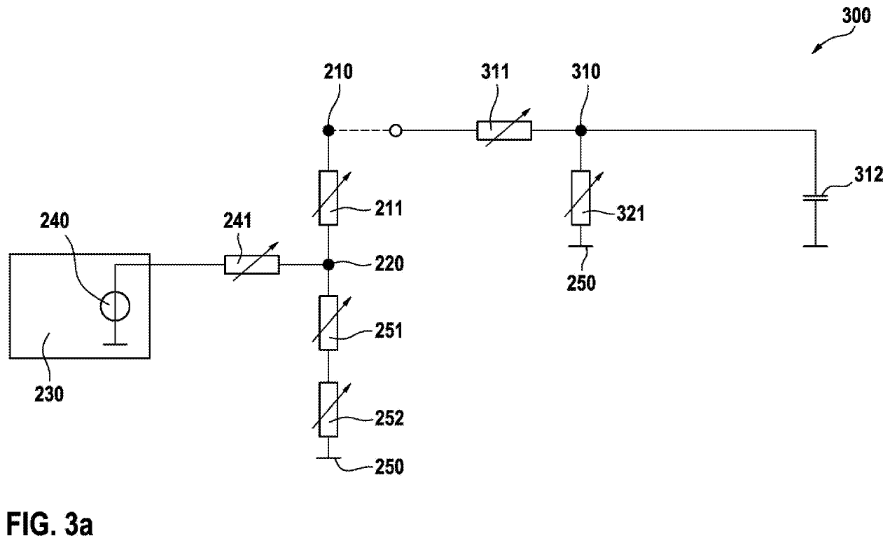

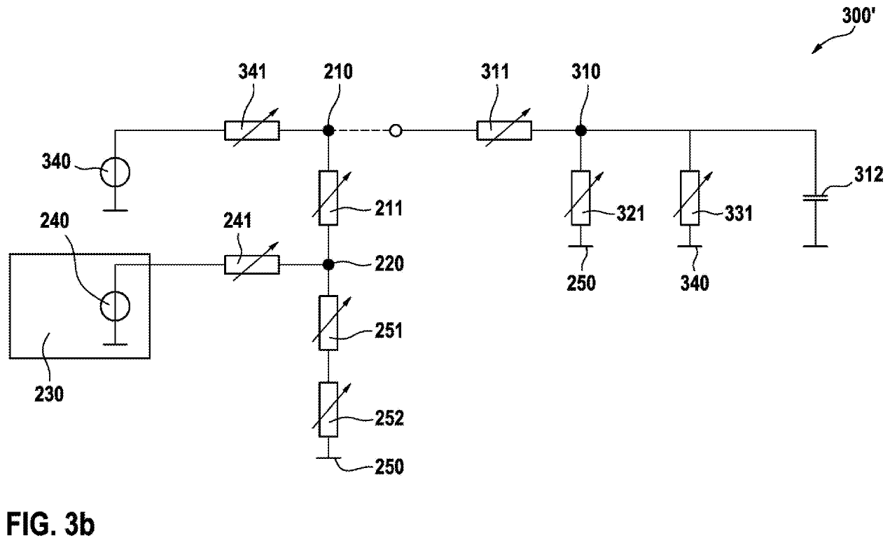

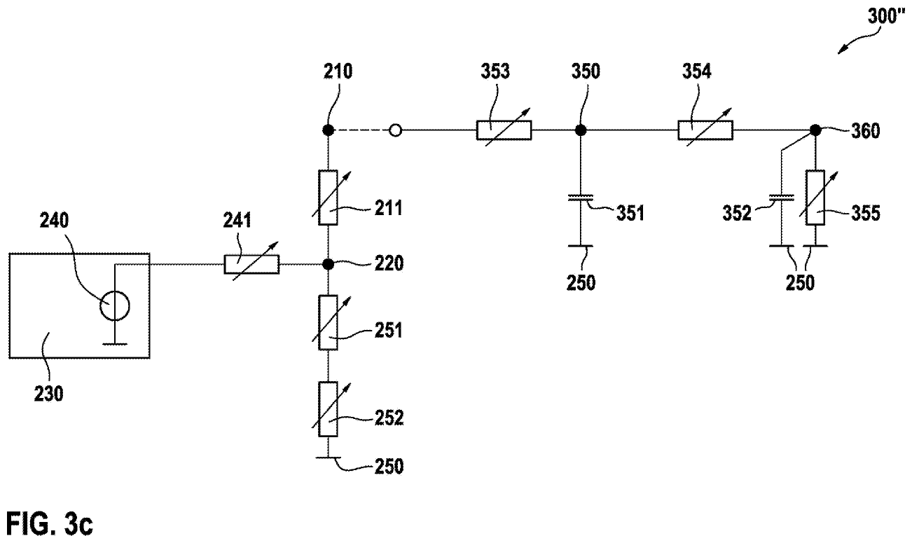

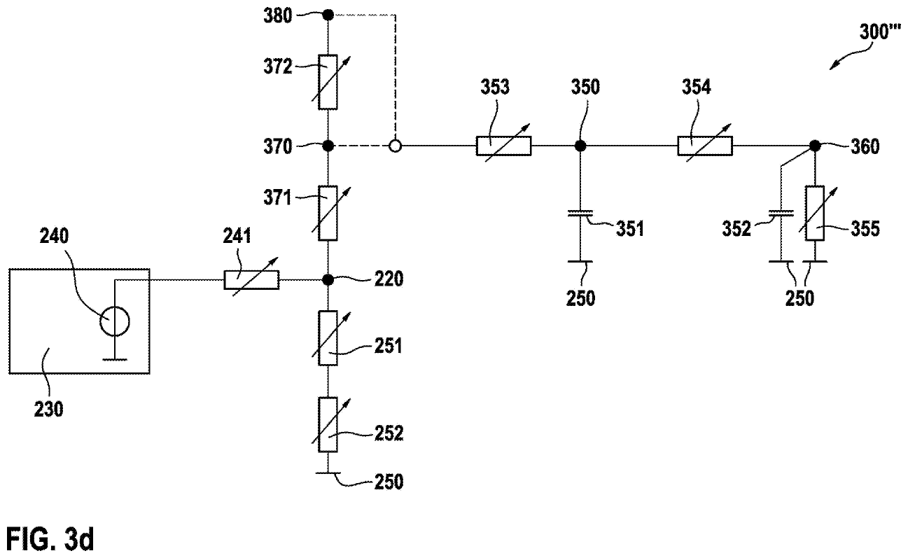

For example, the stator model 200 represents a base version as a forward simulation in which the temperature sensor 130 installed in the stator 120 is not considered. This base model can be extended using the stator temperature sensor 130, as explained below in relation to FIGS. 3a to 3d.

In FIGS. 3a to 3d, a respective stator model according to one embodiment of the method according to the invention is shown schematically, wherein like reference numbers in FIGS. 2, 3a, 3b, 3c and 3d refer to like or equivalent elements.

In FIG. 3a, the embodiment of the extended stator model bears the reference number 300. Furthermore, in the stator model 300, thermal variables are modeled in relation to the temperature sensor 130. The stator model 300 comprises a further nodal point 310 that maps the temperature of the temperature sensor 130. Furthermore, a thermal capacitance 312 of the temperature sensor 130 is modeled, for example as a function of the first working point.

Furthermore, the stator model 300 models a variable thermal resistance 311 between the temperature of the stator coil 122, the temperature of the stator body 121, and the temperature of the temperature sensor 130. For example, the thermal resistance 311 can link the nodal points 210 and 310 with one another and can be determined as a function of the speed and the first working point, R_{cu,sensor}=f(nEm, Op₁).

In the extended stator model 300, a variable thermal resistance 321 between the temperature 250 of the cooling fluid for cooling the stator and the temperature 310 of the temperature sensor 130 is further modeled. This thermal resistance 321 can be determined e.g. as a function of the speed and the first working point, R_{coolant,sensor}=f(n_{Em}, Op₁).

Using the stator temperature sensor 130, the accuracy of the prediction of the stator hotspot temperature can be increased by evaluating the deviation between the measured sensor temperature and the expected, modeled temperature and, for example, a weighted feedback to the stator model 300. For example, a Luenberger Observer, Kalman filter, and/or PI adjuster can be used for this purpose.

The cooling system 140 can further include an oil cooling for cooling the stator 100, wherein the extended stator model can also take into account thermal variables with respect to this oil cooling, as will be discussed below in relation to FIG. 3b.

In FIG. 3b, the embodiment of the extended stator model bears the reference number 300′. As shown in FIG. 3b, the temperature 340 of the oil is specified as a boundary condition. A variable thermal resistance 341 between the temperature 340 of the oil and the temperature 210 of the stator coil 122 is modeled. For example, the cooling path of the oil cooling can be mapped in the stator model 300 by linking it to the first nodal point 210. For example, the thermal resistance 341 between the oil temperature 340 and the temperature of the stator coil 210 can be determined as a function of the speed and a further working point, R_{Cuoil}=f(n_{Em}, Op₃).

This further working point describes, for example, a current combination of torque, speed, phase current, DC link voltage, driving frequency, modulation method, cooling fluid temperature (for cooling the stator 120), flow rate of the cooling fluid for cooling the stator 120, oil temperature, flow rate of the oil, stator power loss, and rotor temperature.

Furthermore, the stator model 300′ comprises a variable thermal resistance 331 between the temperature 340 of the oil and the temperature 310 of the temperature sensor 130, e.g. as a function of speed, the temperature of the oil, and the first working point, R_{oil,sensor}=f(nEm, T_{ÖI}, Op1).

To improve the model of the stator temperature sensor 130, the number of nodes in the sensor sub-model can be increased, as will be explained below in relation to FIG. 3c.

In FIG. 3c, the embodiment of the extended stator model bears the reference number 300″. In the stator model 300″, instead of the nodal point 310 of the model 300 and 300′, a first nodal point 350 and a second nodal point 360 are provided, which respectively map the temperature of the temperature sensor 130. The first nodal point 350 can map, for example, a first temperature Tₛₑₙₛₒᵣ₁ of the temperature sensor 130, and the second nodal point 360 can map, for example, a second temperature, Tₛₑₙₛₒᵣ₂, of the temperature sensor 130. Furthermore, in the stator model 300″, a first thermal capacitance 351 of the first nodal point 350 and a second thermal capacitance 352 of the second nodal point 360 are modeled.

Furthermore, the stator model 300″ models a first variable thermal resistance 353 between the temperature of the stator coil 122 and the first temperature Tₛₑₙₛₒᵣ₁ of the temperature sensor 130. For example, this first thermal resistance 353 can link the nodal points 210 and 350 with one another and can be determined e.g. as a function of the speed and the first working Point, R_{Cu,Sensor1}=f(n_{Em}, Op₁).

A second variable thermal resistance 354 between the first temperature Tₛₑₙₛₒᵣ₁ and the second temperature Tₛₑₙₛₒᵣ₂ of the temperature sensor 130 is modeled and connects the nodal points 350 and 360. This second variable thermal resistance 354 can be determined as a function of the speed and the first working point, R_{Sensor1,Sensor2}=f(n_{Em}, Op₁).

A third variable thermal resistance 355 between the temperature 250 of the cooling fluid for cooling the stator and the second temperature Tₛₑₙₛₒᵣ₂ of the temperature sensor 130 is modeled. For example, this third variable thermal resistance 355 can be determined as a function of the speed and the first working point, R_{coolant,Sensor2}=f(n_{Em}, Op₁).

For example, the accuracy of the models 200, 300, 300′ and 300″ can be further improved by separately considering the portion of the stator coil 122 within the grooves of the stator body 120 and the part of the stator coil 122 that protrudes from the stator body 120, i.e. the coil ends 123, 124. For example, a change can be made in the distribution of the coil losses. For example, stator coil losses can be divided into losses in a coil end and losses in a groove. The coil end losses P_{v,stator,cu,coilend} can be fed into nodal point 210.

The groove losses in the groove P_{v,stator,Cu,Coilgroove} can be fed into the nodal point 220. From knowledge of the respective nodal point temperatures 210 and 220, the individual temperature-dependent electrical resistances in the coil end 123, 124 and in the groove can be determined and updated. The stator iron losses P_{v,stator,Fe} can additionally be fed into the node 220, as explained above.

However, it is also conceivable to add a further node in order to improve model accuracy and to model the stator coil 122 with two nodes, whereby the coil losses in the coil end 123, 124 and the losses in the groove can then be better distributed among the nodes, as explained below in relation to FIG. 3d.

In FIG. 3d, the embodiment of the extended stator model bears the reference number 300″′. In this stator model 300″′, compared to the models 200, 300, 300′, and 300″, the nodal point 210 with respect to the stator coil 122 is replaced by two nodal points 370 and 380, wherein the nodal point 370 maps the stator coil 122 in a coil groove of stator 120, and wherein the nodal point 380 maps a coil end 123, 124.

The nodal point 370 maps the temperature T_{stator,Cu,Coilgroove}, the thermal dissipation loss rate power P_{v,stator,Cu,Coilgroove}, and the thermal capacitance C_{Cu,Coilgroove} of the stator coil 122 in the coil groove as a function of one another. The nodal point 380 maps the temperature T_{stator,Cu,Coilend}, the thermal power dissipation loss rate P_{v,stator,Cu,Coilend}, and the thermal capacitance C_{Cu,Coilend} of the coil end 123, 124 as a function of one another. The losses in the coil end P_{v,stator,Cu,Coilend} and in the groove P_{v,stator,Cu,Coilgroove} can thus be distributed directly to the nodes 370 and 380. The stator iron losses P_{v,stator,Fe} are fed into the nodal point 220, as explained above.

In the stator model 300″, a variable thermal resistance 371 between the nodal point 220 in relation to the stator body 121 and the nodal point 370 in relation to the coil groove is further modeled. This thermal resistance 371 can be determined as a function of the first working point, R_{NODE}220,370=f(Op₁).

A further variable thermal resistance 372 is provided between the nodal point 370 with respect to the coil groove and the nodal point 380 with respect to the coil end. This thermal resistance 372, too, can be determined as a function of the first working point, R_{Node370,380}=f(Op₁).

As shown in FIG. 3d, a direct connection between the nodal point 380 and the resistance 353 can further be provided. This is to be understood in particular in such a way that the linkage of the sensor path, symbolized by the nodes 350 and 360, can be passed optionally over the node 370 or the node 380, in particular depending on the installed location of the sensor and whether a 2-node model symbolized by the nodes 220 and 370 or a 3-node model symbolized by the nodes 220, 370, and 380 is to be used for mapping the stator hotspot temperature.

It is understood that replacing the nodal point 210 with respect to the stator coil 122 with the two nodal points 370 and 380 with respect to the coil groove and the coil end, as discussed herein in relation to the model 300′, can also be applied accordingly to the stator models 200, 300 and 300′.

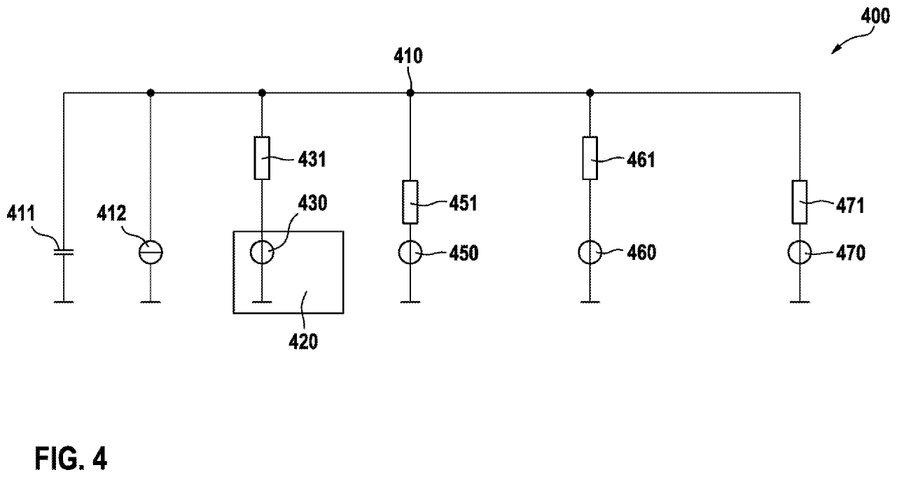

In FIG. 4, a rotor model according to one embodiment of the method according to the invention is shown schematically and bears the reference number 400.

The rotor model 400 is determined independently of the stator model 200 and 300, respectively. In the rotor model 400, a heat exchange between the rotor 110 and the stator 120 is considered independently of the heat exchange in the respective stator model 200 and 300. The stator model 200, 300 and the rotor model 400 are not linked via the heat exchange between the rotor 110 and the stator 120. An energy conservation between the stator model 200, 300 and the rotor model 400 with respect to the heat exchange between the rotor 110 and the stator 120 is not required.

According to the stator model 200 and 300, the rotor model 400 comprises an interface 420 for the temperature 430 of the stator 120, wherein this interface 420 represents an open interface for the heat exchange between the rotor 110 and the stator 120 and an external, open coupling to the temperature 430 of the stator 120. The heat exchange between the rotor 110 and the stator 120 can be accounted for via this interface 420 in the rotor model 400, independently of the stator model 200, 300. For example, the stator temperature 430 can be specified manually or externally via the interface 420, e.g. as a result of the stator model 200, 300.

In the rotor model 400, the temperature 410 of the rotor 110, a thermal capacitance 411 of the rotor 110, and a thermal power dissipation loss rate 412 of the rotor 110 are modeled. For example, this temperature T_{Rotor}, this thermal capacitance C_{Rotor}, and this thermal power dissipation loss rate P_{v,Rotor} of the rotor 110 can be mapped in a nodal point or hotspot for the rotor 110. For example, the thermal power dissipation loss rate 412 and the thermal capacitance 411 of the rotor 110 can respectively be modeled as a function of a second working point related to the rotor 110, wherein the aforementioned second working point describes a combination of current values for the torque, the speed, the phase current, the DC link voltage, the driving frequency, the modulation method, a temperature of the cooling fluid for cooling the stator 100, a flow rate of this cooling fluid for cooling the stator 100, a temperature of the cooling fluid for cooling the rotor 110, a flow rate of this cooling fluid for cooling the rotor 110, a power dissipation loss rate of the rotor 110, the temperature of the stator 120, and the temperature of the gearbox oil.

The rotor model 420 further comprises a variable thermal resistance 431 between the rotor 110 and the stator 120, or between the temperature 410 of the rotor 110 and the temperature 430 of the stator 120, wherein this thermal resistance 431 can be determined as a function of the speed of the electric machine 100 and the second working point, Rₛₜₐₜₒᵣ(n_{Em}, Op₂).

Furthermore, in the rotor model 420, the temperature 450 of the cooling fluid for cooling the stator 100, the temperature 460 of the rotor-internal cooling fluid for cooling the rotor 110, and a temperature 470 of the gearbox oil are modeled as boundary conditions, and a variable thermal resistance 451 between the temperature 410 of the rotor 110 and the temperature 450 of the cooling fluid for cooling the stator 100, a variable thermal resistance 461 between the temperature 410 of the rotor 110 and the temperature 460 of the cooling fluid for cooling the rotor 110 and a variable thermal resistance 471 between the temperature 410 of the rotor 110 and the temperature 470 of the gearbox oil.

The thermal resistance 451 with respect to the temperature 450 of the cooling fluid can be determined as a function of the speed and the second working point, R_{eMachinecoolant}(nEm, OP₂). The thermal resistance 461 with respect to the temperature 460 of the rotor-internal cooling fluid can vary as a function of the speed, temperature, and flow rate of the rotor-internal cooling fluid as well as the second working point, R_{Rotorinternalcoolang}(nEm, T_{Rotorinternalcoolang}, OP₂). The thermal resistance 471 with respect to the temperature 470 of the gearbox oil can be determined as a function of the speed and the second working point, R_{oilGearbox} (n_{Em}, OP₂).

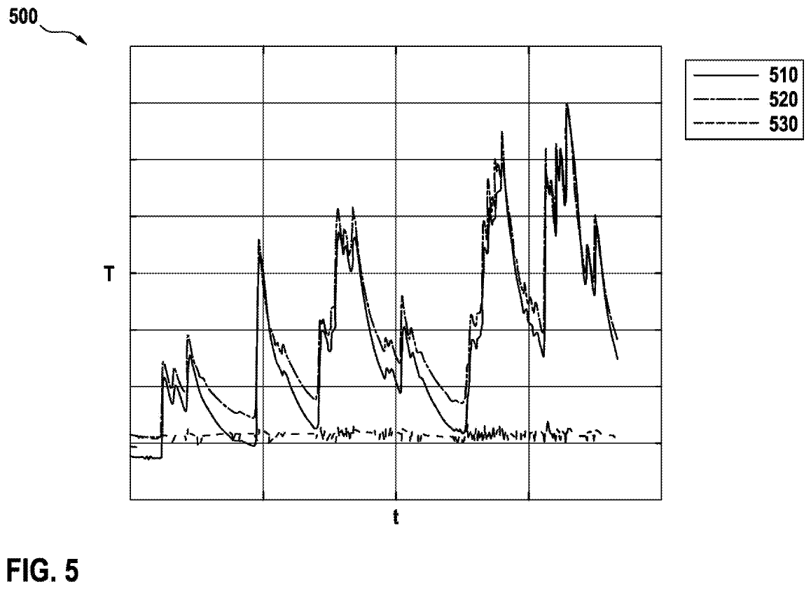

By using the two separate, independent computational models for the stator 120 and the rotor 110 with deliberate softening of or intentional non-adherence to the energy balance between the rotor 110 and the stator 120, the temperatures of the stator 120 and the rotor 110 can be more precisely modeled and determined than would be the case with an overall thermal model of the electric machine 100, in which the heat exchange between the rotor and stator is mapped physically correctly, as explained below on the basis of FIG. 5.

FIG. 5 schematically shows a diagram 500 of a temperature plotted over time.

The curve 510 represents the temporal profile of the maximum stator temperature or stator hotspot temperature actually measured on a test bench during the operation of the electric machine 100.

The curve 520 represents the corresponding stator temperature determined using the stator model 200 according to one embodiment of the invention, which was performed on the control unit 150 during operation of the electric machine 100.

The curve 530 represents the temporal profile of the temperature of the cooling fluid for cooling the stator 120.

As can be seen in FIG. 5, the stator temperature can be replicated relatively accurately using the stator model 200.

1. A method for determining temperatures of an electric machine (100) having a rotor (110) and a stator (120), comprising: determining a first thermal computational model (200, 300, 300′, 300″, 300″′) which models thermal variables of the stator (120);
determining a second thermal computational model (400) which models thermal variables of the rotor (110);
determining a heat exchange between the rotor (110) and the stator (120) in the first thermal computational model (200, 300, 300′, 300″, 300″′) and in the second thermal computational model (400) independently of one another;
determining a temperature of the stator (120) using the first thermal computational model (200, 300, 300′, 300″, 300″′); and
determining a temperature of the rotor (110) using the second thermal computational model.

2. The method according to claim 1, wherein no energy conservation is required between the first thermal computational model (200, 300, 300′, 300″, 300″′) and the second thermal computational model (400) with respect to the heat exchange between the rotor (110) and the stator (120).

3. The method according to claim 1, wherein the first thermal computational model (200, 300, 300′, 300″, 300″′) comprises an interface (230) for the temperature (240) of the rotor (110), and wherein the second thermal computational model (400) comprises an interface (430) for the temperature (420) of the stator (120).

4. The method according to claim 1, further comprising: determining operating parameters of the electric machine (100);
determining the temperature of the stator (120) using the first thermal computational model (200, 300, 300′, 300″, 300″′) as a function of the determined operating parameters; and
determining the temperature of the rotor (110) using the second thermal computational model (400) as a function of the determined operating parameters.

5. The method according to claim 1, wherein the thermal variables of the stator (120) in the first thermal computational model (200, 300, 300′, 300″, 300″′) and/or the thermal variables of the rotor (110) in the second thermal computational model (400) are respectively modeled as a function of one or more of the following operating parameters:
a torque of the electric machine (100);
a speed of the electric machine (100);
a phase current of the electric machine (100);
a DC link voltage of the electric machine (100);
a driving frequency of the electric machine (100);
a modulation method of the electric machine (100);
a temperature of a cooling fluid for cooling the stator (120);
a flow rate of the cooling fluid for cooling the stator (120);
a temperature of a cooling fluid for cooling the rotor (110);
a flow rate of the aforementioned cooling fluid for cooling the rotor (110);
a temperature of a gearbox oil.

6. The method according to claim 1, wherein the first thermal computational model (200, 300) maps thermal variables of a stator body (121) and thermal variables of a stator coil (122) of the stator (120) as a function of one another.

7. The method according to claim 1, wherein the first thermal computational model (200, 300, 300′, 300″) models one or more of the following thermal variables as a function of one another:
a temperature (210) of a stator coil (122) of the stator (120);
a thermal power dissipation loss rate (210) of the stator coil (122);
a thermal capacitance (210) of the stator coil (122);
a temperature (220) of a stator body (121) of the stator (120);
a thermal power dissipation loss rate (220) of the stator body (121);
a thermal capacitance (220) of the stator body (121);
a thermal resistance (211) between the temperature (210) of the stator coil (122) and the temperature (220) of the stator body (121);
a thermal resistance (241) between the rotor (110) and the stator (120);
a temperature (250) of a cooling fluid for cooling the stator (120) and a thermal resistance (251, 252) between the temperature (220) of the stator body (121) and the temperature (250) of the cooling fluid for cooling the stator (120).

8. The method according to claim 1, wherein the first thermal computational model (300″′) models one or more of the following thermal variables as a function of one another:
a temperature (370) of the stator coil (122) in a coil groove of the stator (120);
a thermal power dissipation loss rate (370) of the stator coil (122) in the coil groove of the stator (120);
a thermal capacitance (370) of a stator coil (122) in the coil groove of the stator (120);
a temperature (380) of a coil end (123, 124) of the stator (120);
a thermal power dissipation loss rate (380) of the coil end (123, 124) of the stator (120);
a thermal capacitance (380) of the coil end (123, 124) of the stator (120);
a temperature (220) of a stator body (121) of the stator (120);
a thermal power dissipation loss rate (220) of the stator body (121);
a thermal capacitance (220) of the stator body (121);
a thermal resistance (371) between the temperature (370) of the stator coil (122) in the coil groove of the stator (120) and the temperature (220) of the stator body (121);
a thermal resistance (372) between the temperature (370) of the stator coil (122) in the coil groove of the stator (120) and the temperature (380) of the coil end (123, 124) of the stator (120).
a thermal resistance (241) between the rotor (110) and the stator (120);
a temperature (250) of a cooling fluid for cooling the stator (120) and a thermal resistance (251, 252) between the temperature (220) of the stator body (121) and the temperature (250) of the cooling fluid for cooling the stator (120).

9. The method according to claim 1, wherein the second thermal computational model (400) models one or more of the following thermal variables as a function of one another:
the temperature (410) of the rotor (110);
a thermal power dissipation loss rate (412) of the rotor (110);
a thermal capacitance (411) of the rotor (110);
a thermal resistance (431) between the rotor (110) and the stator (120);
a temperature (450) of a cooling fluid for cooling the stator (100);
a thermal resistance (451) between the rotor (110) and the cooling fluid for cooling the stator (100);
a temperature (460) of a cooling fluid for cooling the rotor (110);
a thermal resistance (461) between the rotor (110) and the cooling fluid for cooling the rotor (110);
a temperature (470) of a gearbox oil;
a thermal resistance (471) between the rotor (110) and the gearbox oil.

10. The method according to claim 1, wherein the electric machine (100) comprises a temperature sensor (130) arranged on or in the stator (120), wherein the first thermal computational model (300, 300′) models one or more of the following thermal variables as a function of one another:
a temperature (310) of the temperature sensor (130);
a thermal capacitance (312) of the temperature sensor (130);
a thermal resistance (311) between the temperature of a stator coil (122), the temperature of a stator body (121), and the temperature (310) of the temperature sensor (130);
a temperature (250) of a cooling fluid for cooling the stator (120);
a thermal resistance (321) between the temperature (250) of the cooling fluid for cooling the stator (120) and the temperature (310) of the temperature sensor (130);
a temperature (340) of an oil;
a thermal resistance (331) between the temperature (340) of the oil and the temperature (310) of the temperature sensor (130).

11. The method according to claim 1, wherein the electric machine (100) comprises a temperature sensor (130) arranged on or in the stator (120), wherein the first thermal computational model (300″, 300″′) models one or more of the following thermal variables as a function of one another:
a first temperature (350) of the temperature sensor (130);
a second temperature (360) of the temperature sensor (130);
a first thermal capacitance (351) of the temperature sensor (130);
a second thermal capacitance (352) of the temperature sensor (130);
a first thermal resistance (353) between the temperature of a stator coil (122) and the first temperature (350) of the temperature sensor (130);
a second thermal resistance (354) between the first temperature (350) of the temperature sensor (130) and the second temperature (360) of the temperature sensor (130);
a temperature (250) of a cooling fluid for cooling the stator (120);
a third thermal resistance (355) between the temperature (250) of the cooling fluid for cooling the stator (120) and the second temperature (360) of the temperature sensor (130).

12. The method according to claim 1, wherein the electric machine (100) comprises an oil cooling, wherein the first thermal computational model (300′) models one or more of the following thermal variables as a function of one another:
a temperature (340) of an oil of the oil cooling;
a thermal resistance (341) between the temperature (340) of the oil of the oil cooling and the temperature (210) of a stator coil (122).

13. A computer (150) configured to determine temperatures of an electric machine (100) having a rotor (110) and a stator (120), by:
determining a first thermal computational model (200, 300, 300′, 300″, 300″′) which models thermal variables of the stator (120);
determining a second thermal computational model (400) which models thermal variables of the rotor (110);
determining a heat exchange between the rotor (110) and the stator (120) in the first thermal computational model (200, 300, 300′, 300″, 300″′) and in the second thermal computational model (400) independently of one another;
determining a temperature of the stator (120) using the first thermal computational model (200, 300, 300′, 300″, 300″′); and
determining a temperature of the rotor (110) using the second thermal computational model.

14. (canceled)

15. A non-transitory, machine-readable medium comprising instructions that when executed by a computer cause the computer to determine temperatures of an electric machine (100) having a rotor (110) and a stator (120), by:
determining a first thermal computational model (200, 300, 300′, 300″, 300″′) which models thermal variables of the stator (120);
determining a second thermal computational model (400) which models thermal variables of the rotor (110);
determining a heat exchange between the rotor (110) and the stator (120) in the first thermal computational model (200, 300, 300′, 300″, 300″′) and in the second thermal computational model (400) independently of one another;
determining a temperature of the stator (120) using the first thermal computational model (200, 300, 300′, 300″, 300″′); and
determining a temperature of the rotor (110) using the second thermal computational model.
